(19) United States
(12) Patent Application Publication
(10) Pub. No.: US 2019/0041312 A1
(43) Pub. Date: Feb. 7, 2019

(54) SYSTEM AND METHOD FOR METAL POWDER QUALITY INSPECTION AND ANALYSIS

(71) Applicant: Vibe Imaging Analytics Ltd., Bnei-Brak (IL)

(72) Inventor: Ron Hadar, Capitola, CA (US)

(21) Appl. No.: 16/049,922

(22) Filed: Jul. 31, 2018

Related U.S. Application Data
(60) Provisional application No. 62/605,092, filed on Aug. 1, 2017.

(51) Int. Cl. G01N 15/02; B33Y 50/00; G01N 15/14; G06Q 50/04

(52) U.S. Cl. CPC G01N 15/0227; B33Y 50/00; G01N 2015/1087; G01N 15/1425; G06Q 50/04; G01N 15/1429

(57) ABSTRACT

A system and method for inspecting the quality of the metal powder based on automatic visual inspection.

### CROSS-REFERENCE TO RELATED APPLICATIONS

This application claims priority to U.S. provisional patent application Ser. No. 62/605,092, titled “Machine Vision for Metal Powder Quality Inspection”, which was filed on Aug. 1, 2017, the entire specification of which is incorporated herein by reference.

### BACKGROUND

### Field of the Art

The disclosure relates to the field of metal powder processing, and more particularly to the field of metal powder inspection and analysis.

### Discussion of the State of the Art

The 3D printing is fast growing market. 3D printing techniques can shape objects from an ever-growing type of materials, from photo-polymeric resins, extruded filament, powders of plastics, pure metals and alloys, etc. Metal powder used fusion, directed energy deposition and other methods and technologies in development that are capable of producing high-quality, functional and load parts from a variety of metallic powder materials. However, “one-size-fits-all” doesn't apply well to industrial additive manufacturing and when it comes to high value parts and critical applications, it's crucial to know the quality of chosen powder material. Metal powders can vary widely in size, in shape, spherical to irregular. As a consequence, processing characteristics in metal systems vary, as well. The proposed invention, an instrument to inspect the quality of the powder based on automatic visual inspection, based on image capturing (image of powder sample particles), image processing to separate each particle or to look at it as a whole, particle measurement for dimensions and calculation and classifications of areas and shapes and color for overall reporting on the quality based on parametric data and machine learning on the purity of the powder, thus will ensure consistency and repeatability of the quality of metal powders and the final product produced from this powder.

What is needed is a system and method for inspecting the quality of the metal powder based on automatic visual inspection, based on image capturing (image of powder sample particles), image processing to separate each particle or to look at it as a whole, particle measurement for dimensions and calculation and classifications of areas and shapes and color for overall reporting on the quality based on parametric data and machine learning on the purity of the powder, which will ensure consistency and repeatability of the quality of metal powders and the final product produced from this powder.

### SUMMARY

Accordingly, the inventor has conceived and reduced to practice, a system and method for inspecting the quality of the metal powder based on automatic visual inspection.

According to one embodiment, a system for inspecting the quality of the metal powder based on automatic visual inspection is disclosed, comprising: an imagine machine and software for analyzing the images.

According to one embodiment, a method for inspecting the quality of the metal powder based on automatic visual inspection is disclosed, comprising the steps of: acquiring images of metal powder analyzing the images using software.

### BRIEF DESCRIPTION OF THE DRAWING FIGURES

The accompanying drawings illustrate several aspects and, together with the description, serve to explain the principles of the invention according to the aspects. It will be appreciated by one skilled in the art that the particular arrangements illustrated in the drawings are merely exemplary, and are not to be considered as limiting of the scope of the invention or the claims herein in any way.

FIG. 1 is a diagram illustrating an exemplary system architecture for inspection of metal powder.

FIG. 2 is a diagram illustrating an exemplary method for inspection of metal powder.

FIG. 3 is a diagram illustrating an exemplary system for inspection of metal powder.

FIG. 4 is a diagram illustrating an exemplary aspect of a system for inspection of metal powder.

FIG. 5 is a diagram illustrating an exemplary screens from software for inspection of metal powder.

FIG. 6 is a diagram illustrating an exemplary screens from cloud-based software for inspection of metal powder.

FIG. 7 is a diagram illustrating an exemplary analysis of for inspection of metal powder.

FIG. 8 is a diagram illustrating an exemplary resolution quality for inspection of metal powder.

FIG. 9 is a diagram illustrating an exemplary network architecture for inspection of metal powder.

FIG. 10 is a diagram illustrating an exemplary process for inspection of metal powder.

FIG. 11 is a block diagram illustrating an exemplary hardware architecture of a computing device.

FIG. 12 is a block diagram illustrating an exemplary logical architecture for a client device.

FIG. 13 is a block diagram showing an exemplary architectural arrangement of clients, servers, and external services.

FIG. 14 is another block diagram illustrating an exemplary hardware architecture of a computing device.

### DETAILED DESCRIPTION

The inventor has conceived, and reduced to practice, a system and method for inspecting the quality of the metal powder based on automatic visual inspection.

The proposed invention, an instrument to inspect the quality of the powder based on automatic visual inspection, based on image capturing (image of powder sample particles), image processing to separate each particle or to look at it as a whole, particle measurement for dimensions and calculation and classifications of areas and shapes and color for overall reporting on the quality based on parametric data and machine learning on the purity of the powder, thus will ensure consistency and repeatability of the quality of metal powders and the final product produced from this powder.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

Various embodiments of the present disclosure may be implemented in computer hardware, firmware, software, and/or combinations thereof. Methods of the present disclosure can be implemented via a computer program instructions stored on one or more non-transitory computer-readable storage devices for execution by a processor. Likewise, various processes (or portions thereof) of the present disclosure can be performed by a processor executing computer program instructions. Embodiments of the present disclosure may be implemented via one or more computer programs that are executable on a computer system including at least one processor coupled to receive data and instructions from, and to transmit data and instructions to, a data storage system, at least one input device, and at least one output device. Each computer program can be implemented in any suitable manner, including via a high-level procedural or object-oriented programming language and/or via assembly or machine language. Systems of the present disclosure may include, by way of example, both general and special purpose microprocessors which may retrieve instructions and data to and from various types of volatile and/or non-volatile memory. Computer systems operating in conjunction with the embodiments of the present disclosure may include one or more mass storage devices for storing data files, which may include: magnetic disks, such as internal hard disks and removable disks; magneto-optical disks; and optical disks. Storage devices suitable for tangibly embodying computer program instructions and data (also called the “non-transitory computer-readable storage media”) include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits) and other forms of hardware.

Changes and modifications may be made to the disclosed embodiments without departing from the scope of the present disclosure. These and other changes or modifications are intended to be included within the scope of the present disclosure, as expressed in the following claims.

### Conceptual Architecture

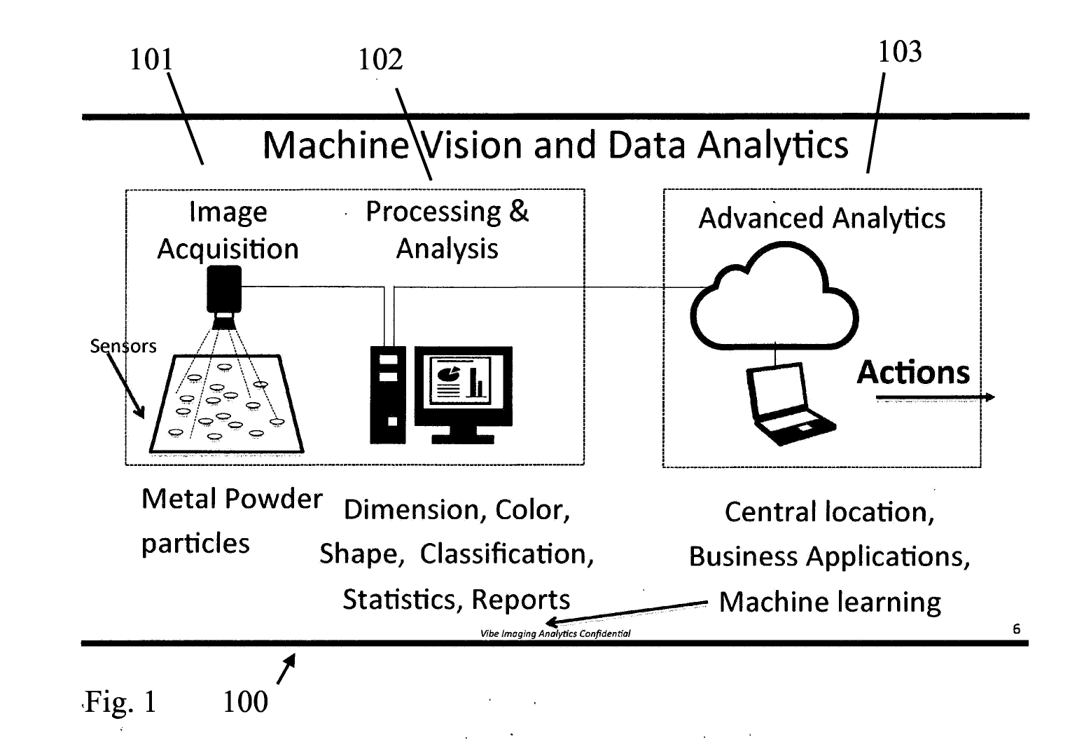

FIG. 1 is a diagram illustrating an exemplary system architecture for inspection of metal powder 100. An imaging machine 101 captures an image and sends it to a computer 102 for processing and analysis 103.

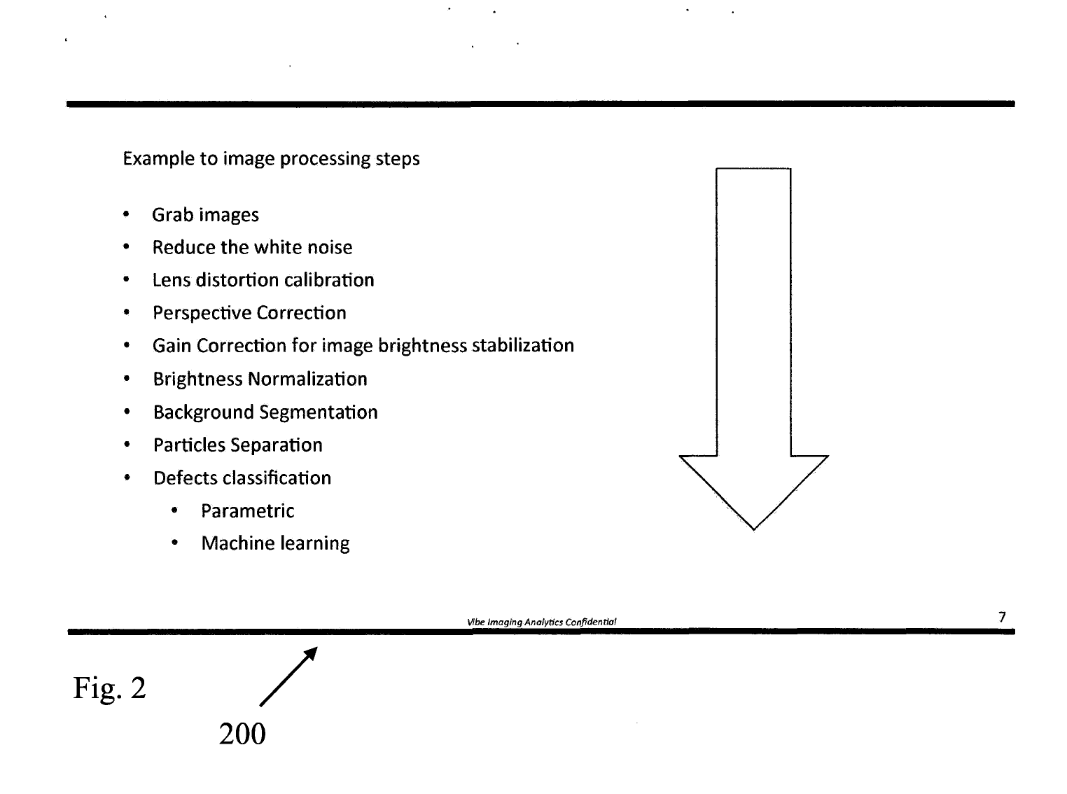

FIG. 2 is a diagram illustrating an exemplary method for inspection of metal powder 200.

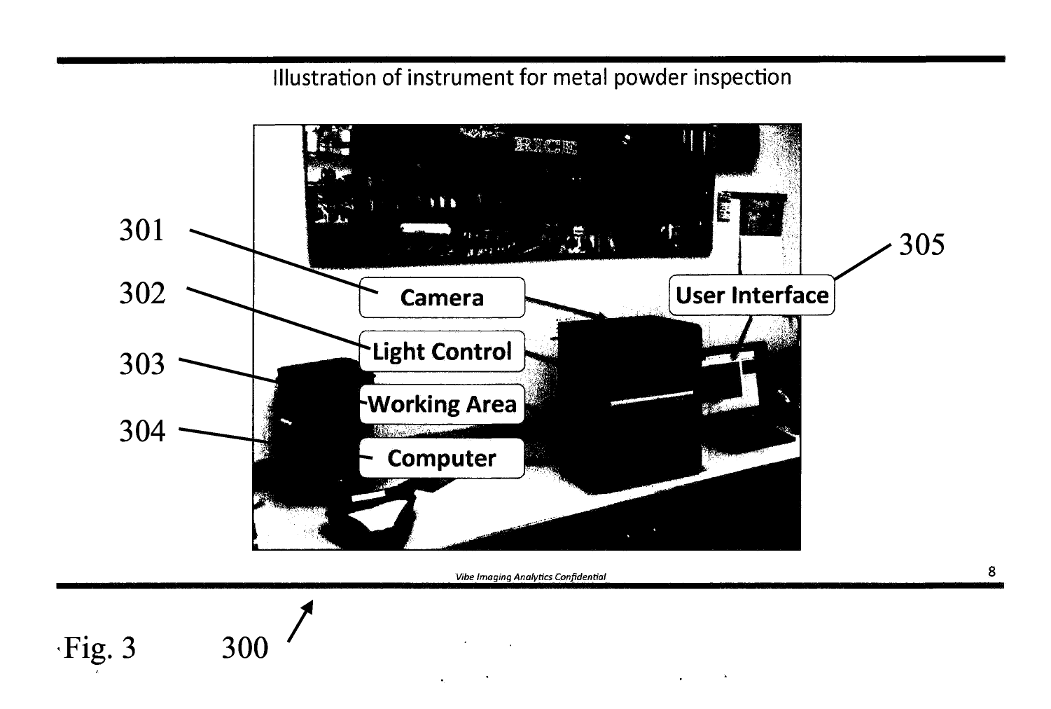

FIG. 3 is a diagram illustrating an exemplary system for inspection of metal powder 300, comprising a camera 301, a light control 302, a working area, 303, a computer 304, and a user interface 305.

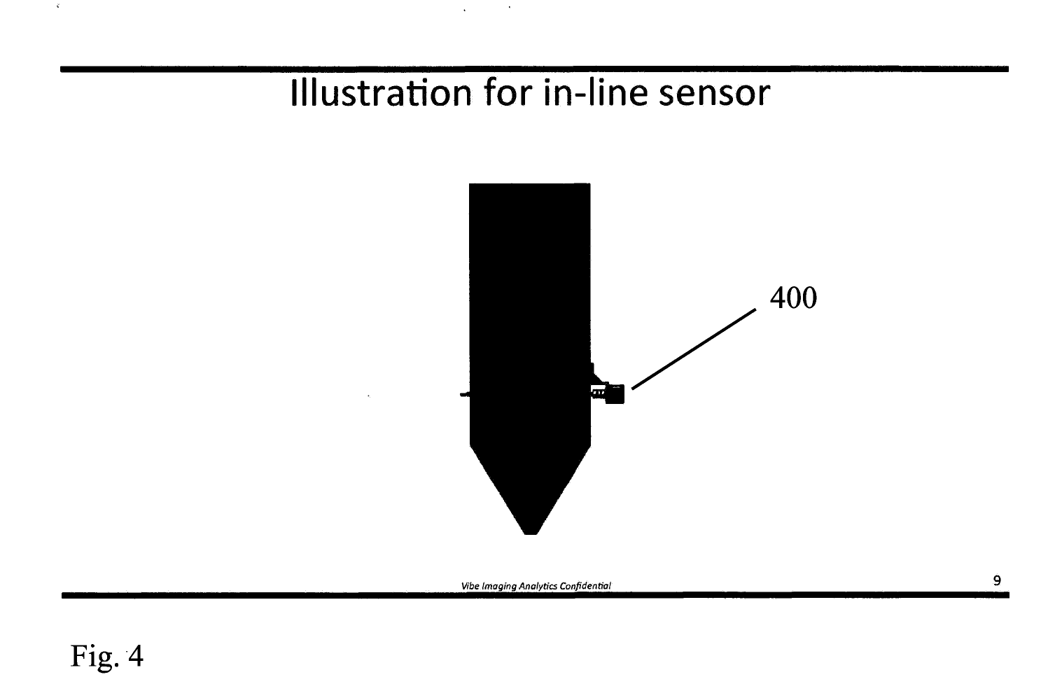

FIG. 4 is a diagram illustrating an exemplary aspect of a system for inspection of metal powder, an in-line sensor 400.

### Detailed Description of Exemplary Aspects

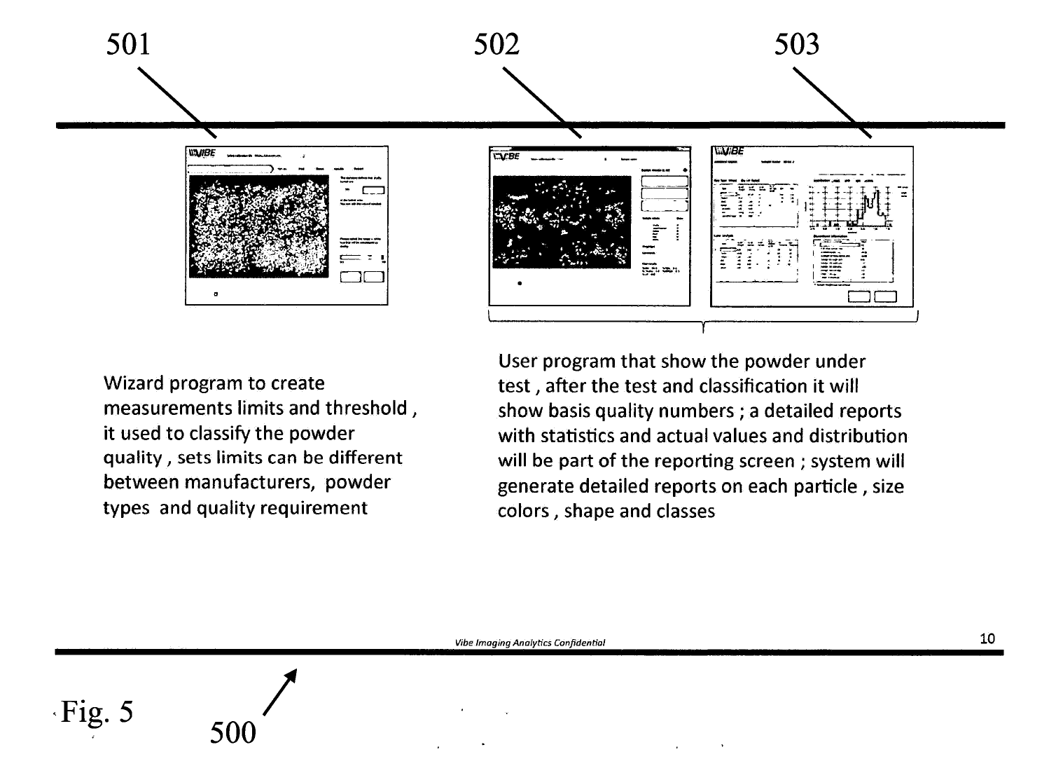

FIG. 5 is a diagram illustrating an exemplary screens 500 from software for inspection of metal powder. There may be a wizard 501 to assist in setup, an image screen 502 showing the images, and a data screen 503 showing the data.

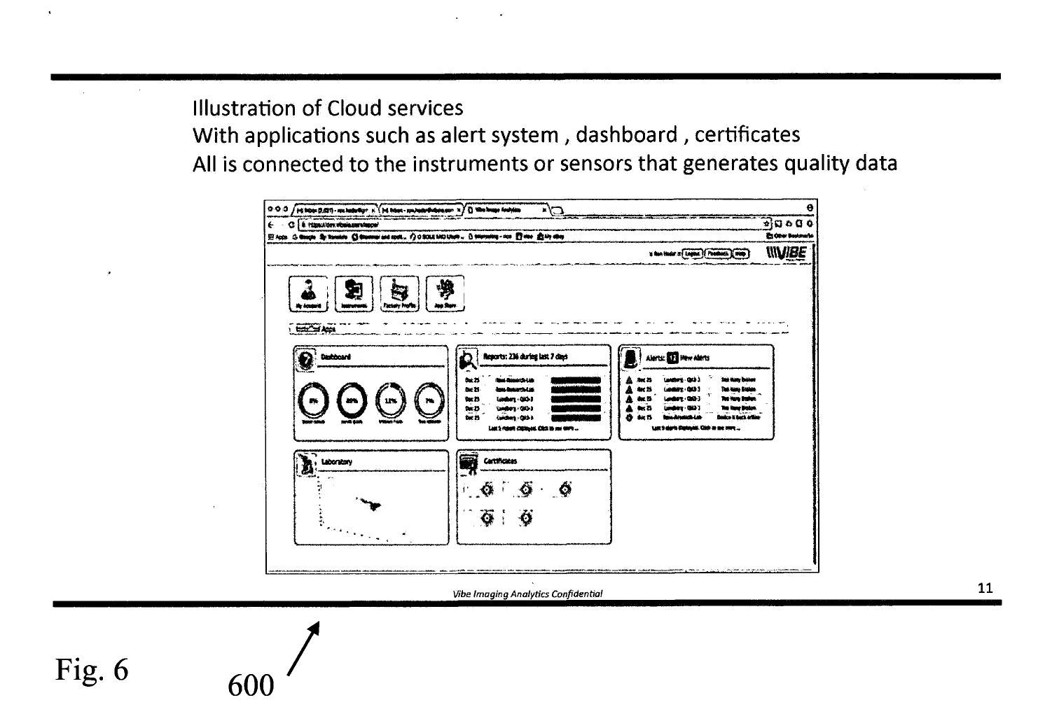

FIG. 6 is a diagram illustrating an exemplary screen from cloud-based software for inspection of metal powder 600.

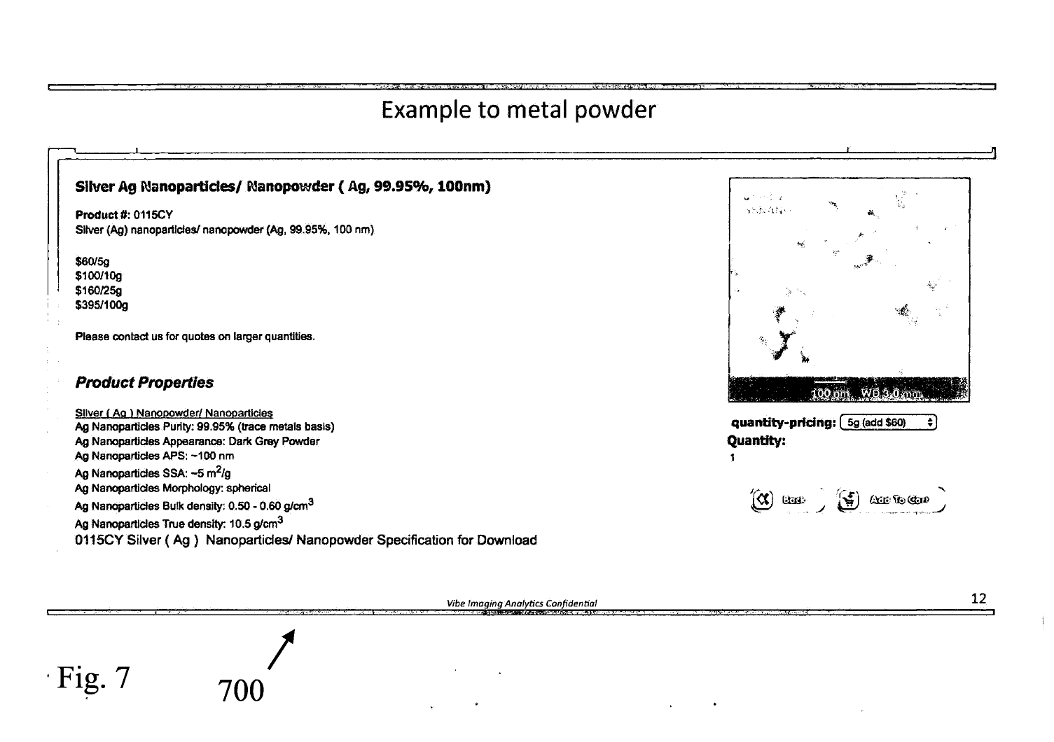

FIG. 7 is a diagram illustrating an exemplary analysis screen for inspection of metal powder 700.

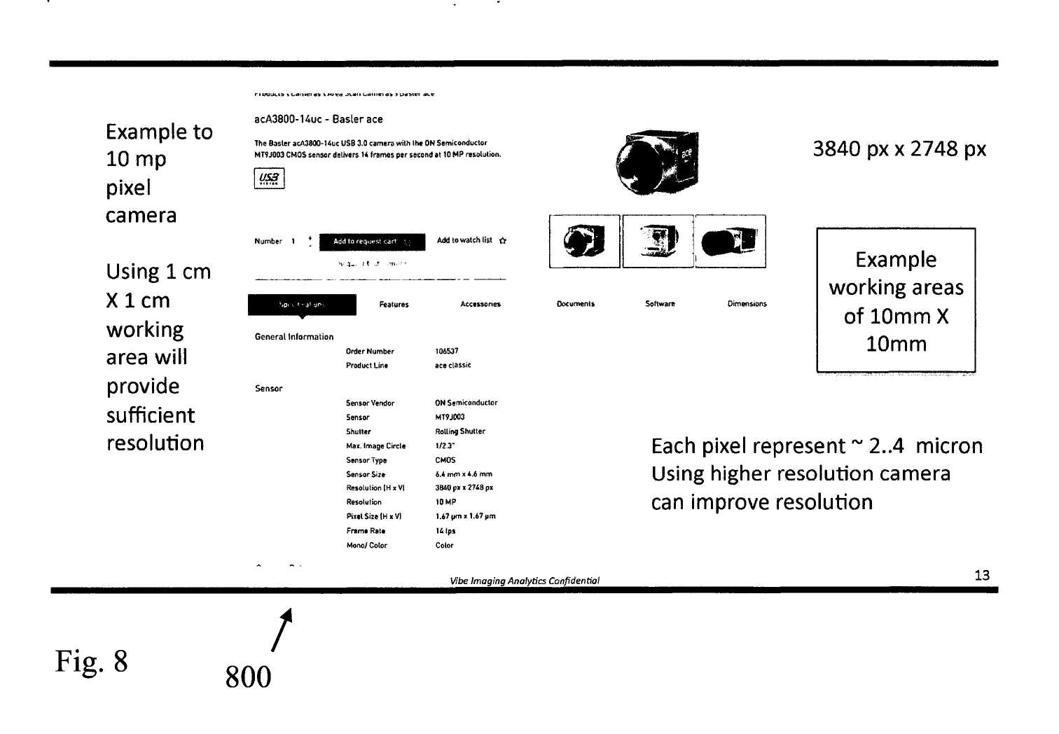

FIG. 8 is a diagram illustrating an exemplary resolution quality for inspection of metal powder 800.

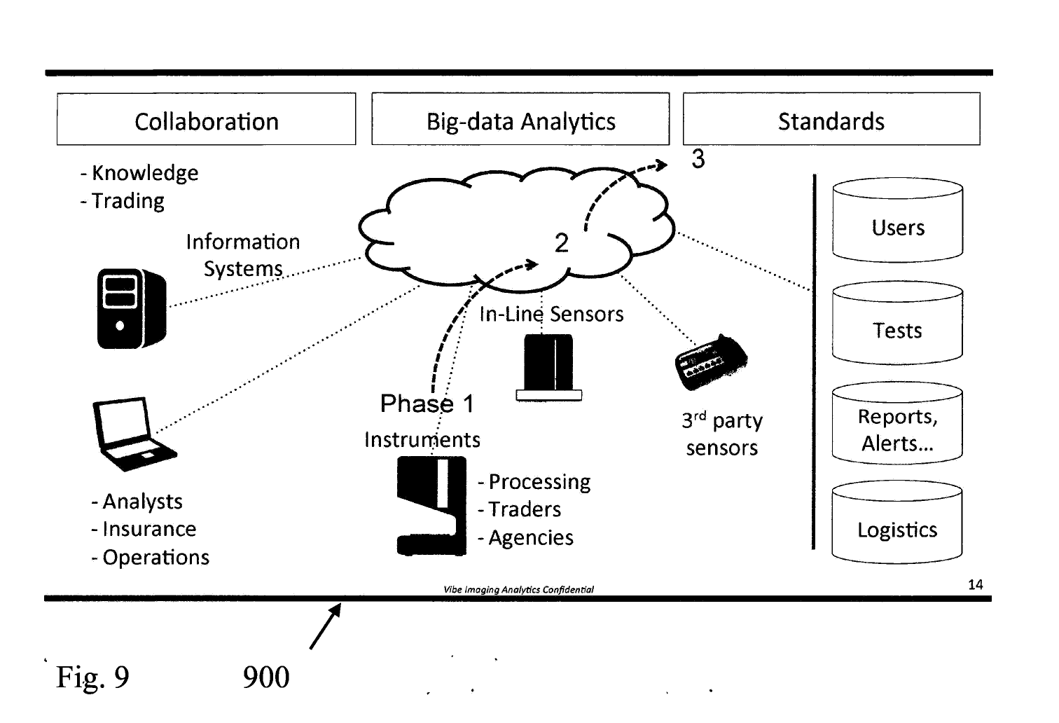

FIG. 9 is a diagram illustrating an exemplary network architecture for inspection of metal powder 900.

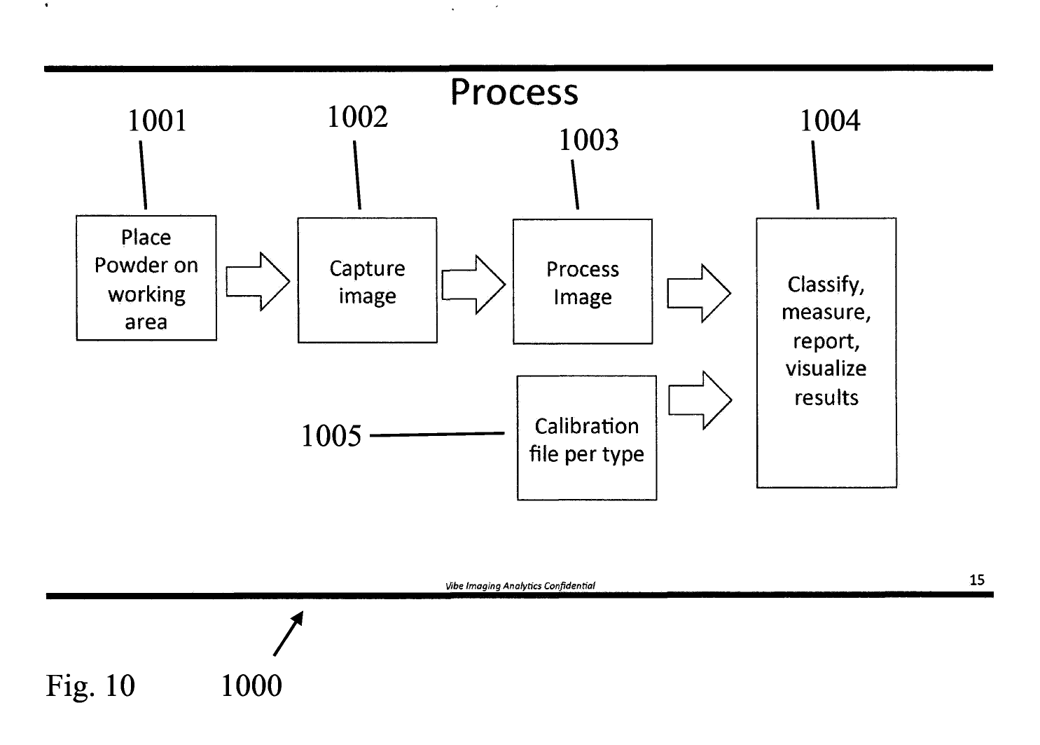

FIG. 10 is a diagram illustrating an exemplary process for inspection of metal powder 1000, comprising the steps of placing the powder on the work area 1001, capturing the image 1002, processing the image 1003, and analyzing the data 1004. There may be step for calibration of the system 1005.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the aspects disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific aspects, at least some of the features or functionalities of the various aspects disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some aspects, at least some of the features or functionalities of the various aspects disclosed herein may be implemented in one or more virtualized computing environments (e.g., network computing clouds, virtual machines hosted on one or more physical computing machines, or other appropriate virtual environments).

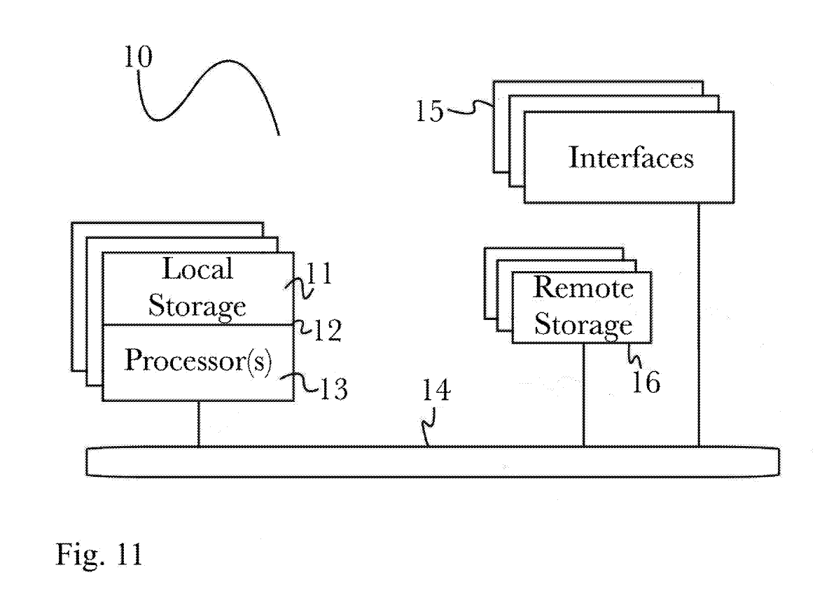

Referring now to FIG. 11, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some aspects, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity AN hardware interfaces) and, in some instances, volatile and/or non-volatile memory (e.g., RAM).

Although the system shown in FIG. 11 illustrates one specific architecture for a computing device 10 for implementing one or more of the aspects described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, a single processor 13 handles communications as well as routing computations, while in other aspects a separate dedicated communications processor may be provided. In various aspects, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the aspects described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device aspects may include nontransitory machine-readable storage media, which, for example, may be configured or designed to store program instructions, state information, and the like for performing various operations described herein. Examples of such nontransitory machine- readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

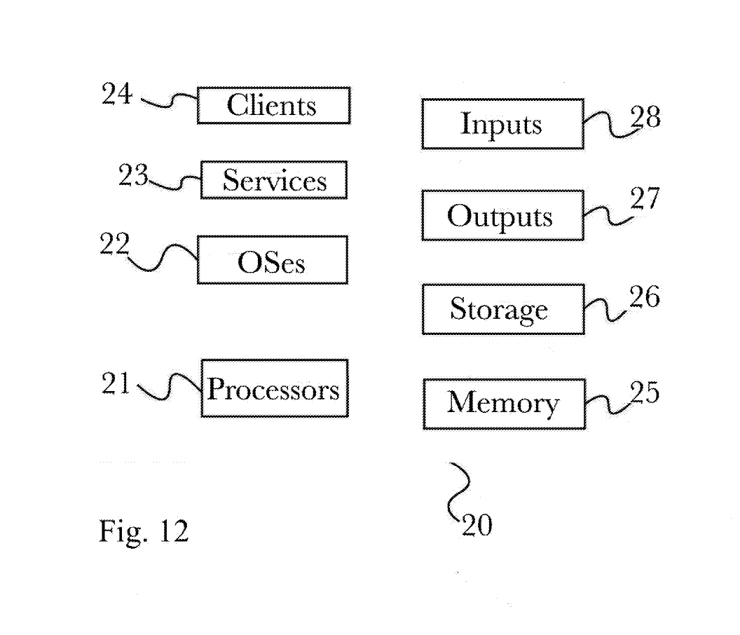

In some aspects, systems may be implemented on a standalone computing system. Referring now to FIG. 12, there is shown a block diagram depicting a typical exemplary architecture of one or more aspects or components thereof on a standalone computing system. Computing device 20 includes processors 21 that may run software that carry out one or more functions or applications of aspects, such as for example a client application 24. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 11). Examples of storage devices 26 include flash memory, magnetic hard drive, CD-ROM, and/or the like.

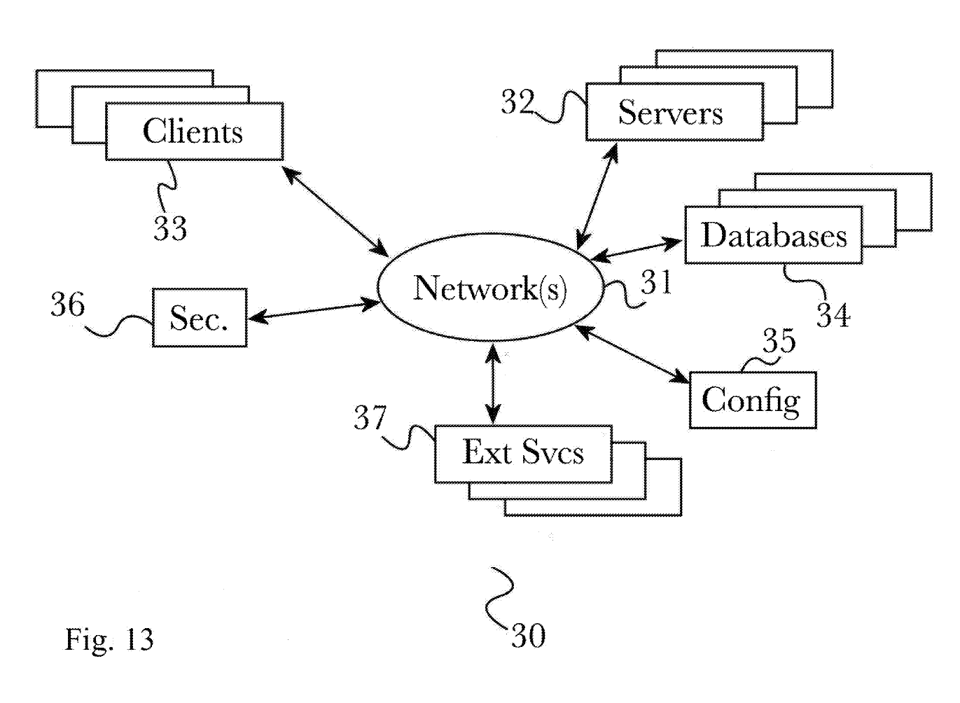

In some aspects, systems may be implemented on a distributed computing network, such as one having any number of clients and/or servers. Referring now to FIG. 13, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 12. In addition, any number of servers 32 may be provided for handling requests received from one or more clients 33. Clients 33 and servers 32 may communicate with one another via one or more electronic networks 31, which may be in various aspects any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some aspects, servers 32 may call external services 37 when needed to obtain additional information, or to refer to additional data concerning a particular call. Communications with external services 37 may take place, for example, via one or more networks 31. In various aspects, external services 37 may comprise web-enabled services or functionality related to or installed on the hardware device itself. For example, in one aspect where client applications 24 are implemented on a smartphone or other electronic device, client applications 24 may obtain information stored in a server system 32 in the cloud or on an external service 37 deployed on one or more of a particular enterprise's or user's premises.

In some aspects, clients 33 or servers 32 (or both) may make use of one or more specialized services or appliances that may be deployed locally or remotely across one or more networks 31. For example, one or more databases 34 may be used or referred to by one or more aspects. It should be understood by one having ordinary skill in the art that databases 34 may be arranged in a wide variety of architectures and using a wide variety of data access and manipulation means. For example, in various aspects one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some aspects, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some aspects may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with aspects without limitation, unless a specific security 36 or configuration system 35 or approach is specifically required by the description of any specific aspect.

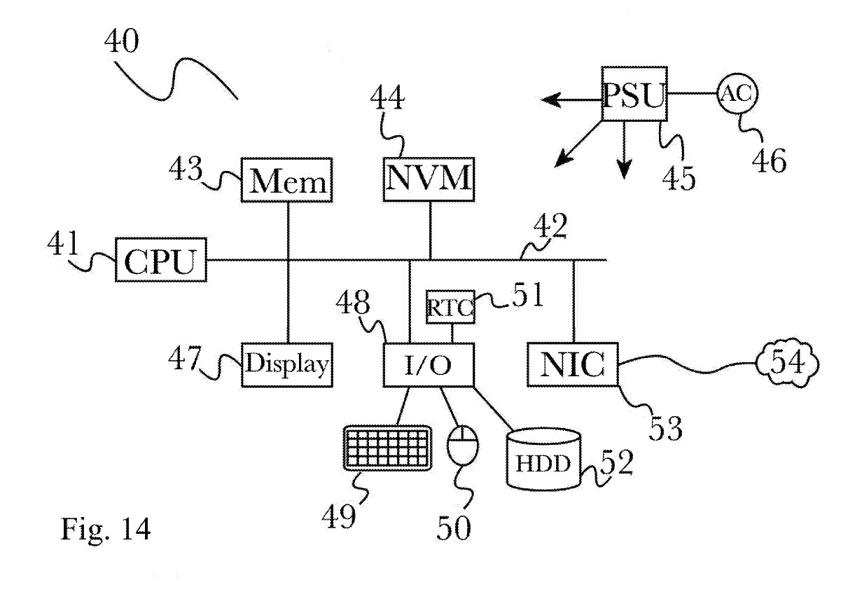

FIG. 14 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various aspects, functionality for implementing systems or methods of various aspects may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various aspects described above. Accordingly, the present invention is defined by the claims and their equivalents.

What is claimed is:

1. A system for inspecting the quality of the metal powder based on automatic visual inspection, comprising:
a platform for metal powder particles inspection;
a feeder to feed a limited amount of the particles to be inspected;
a dish to receive and spread mechanically said particles for a camera to inspect said particles; and
a light system to generate one or more types of light, distinguished both by intensity, duration, spectrum(s) as well as direction, and one or more high resolution cameras,
all elements herein connect to a computing device within with a processor, memory, permanent program storage, interfaces, network interfaces as required and user interfaces as needed, allowing to capture each particle in sufficient resolution, as to allowing assessment of any type of damage that could affect its 3D printing process and the quality of the final product

2. The system of claim 1, wherein the dish can be mechanically manipulated to further spread the particles in case they are grouped to close together, for example by including but not limited to vibration, shaking, rotating etc.

3. The system of claim 1, wherein light can come from above or below the dish.

4. The system of claim 1, wherein light (including invisible light) can be generated by either a one or more of LEDs of different color, or specialized uni-or multi-spectral halide or xenon or similar discharge lamps, or any other suitable combination, with or without additional external filters.

5. The system of claim 4, wherein during electronic sampling of the particles with the camera, the lights can be sequenced as needed by software in said computing device to achieve best imaging and contrast for certain types any other damages.

6. The system of claim 1, wherein additionally to cameras, other sensor types can be employed, including but not limited to moister, scanner, temperature, scales and scanner and wherein the data of any one of the sensors and cameras can be used alone or in any combination.

7. The system of claim 1, wherein the data is used to measuring dimensions, colors and color of particles or any other damage to each particle, allowing the system to identify the particle type, its variety and the damages sustained.

8. The system of claim 7, wherein for each particle a pixel count is calculated and then organized in a histogram for color and size.

9. The system of claim 7, wherein histograms for color and size are hierarchical and used to identify and help quickly categorize particles, damages, qualities etc.

10. The system of claim 7, wherein the data is sent over a network to a server or a cloud, and compared to a reference database.

11. The system of claim 7, wherein changes in data over time are tracked by regions, allowing companies, government and NGOs to assess the powder quality and sufficiency of the supply chain, and recognize supply problems stemming from new damages quickly and early on.

12. The system of claim 1, but implemented in a 3D printers or other 3D system, diverting every now and then based on a time or location etc. schedule a sample from the manufacturing, allowing to create a near real-time quality map, communicate that to both head quarter and other entities as well as optimize process preparation during production.

13. A method for inspecting the quality of the metal powder based on automatic visual inspection, comprising the steps of:
placing metal powder on a platform;
receiving and spreading mechanically said particles for a camera to inspect said particles; and
lighting the particles,
connecting to a computing device within with a processor, memory, permanent program storage, interfaces, network interfaces as required and user interfaces as needed, allowing to capture each particle in sufficient resolution, as to allowing assessment of any type of damage that could affect its 3D printing process and the quality of the final product

14. The method of claim 13, wherein the particles can be mechanically manipulated to further spread the particles in case they are grouped to close together, for example by including but not limited to vibration, shaking, rotating etc.

15. The method of claim 13, wherein light can come from above or below the dish.

16. The method of claim 13, wherein light (including invisible light) can be generated by either a one or more of LEDs of different color, or specialized uni-or multi-spectral halide or xenon or similar discharge lamps, or any other suitable combination, with or without additional external filters.

17. The method of claim 16, wherein during electronic sampling of the particles with the camera, the lights can be sequenced as needed by software in said computing device to achieve best imaging and contrast for certain types any other damages.

18. The method of claim 13, wherein additionally to cameras, other sensor types can be employed, including but not limited to moister, scanner, temperature, scales and scanner and wherein the data of any one of the sensors and cameras can be used alone or in any combination.

19. The method of claim 13, wherein the data is used to measuring dimensions, colors and color of particles or any other damage to each particle, allowing the system to identify the particle type, its variety and the damages sustained.

20. The system of claim 19, wherein for each particle a pixel count is calculated and then organized in a histogram for color and size.

21. The system of claim 19, wherein histograms for color and size are hierarchical and used to identify and help quickly categorize particles, damages, qualities etc.

22. The system of claim 19, wherein the data is sent over a network to a server or a cloud, and compared to a reference database.

23. The system of claim 19, wherein changes in data over time are tracked by regions, allowing companies, government and NGOs to assess the powder quality and sufficiency of the supply chain, and recognize supply problems stemming from new damages quickly and early on.

24. The system of claim 19, but implemented in a 3D printers or other 3D system, diverting every now and then based on a time or location etc. schedule a sample from the manufacturing, allowing to create a near real-time quality map, communicate that to both head quarter and other entities as well as optimize process preparation during production.
